(19) United States
(12) Patent Application Publication
(10) Pub. No.: US 2026/0054474 A1
(43) Pub. Date: Feb. 26, 2026

(54) Rough Board Compositing Process

(71) Applicant: HSIU-YUEH LU, Taichung (CN)

(72) Inventor: HSIU-YUEH LU, Taichung (CN)

(21) Appl. No.: 18/814,382

(22) Filed: Aug. 23, 2024

(51) Int. Cl. B32B 37/02; B32B 5/06; B32B 7/022; B32B 27/12; B32B 37/08; B32B 37/10; B32B 38/00; B32B 43/00

(52) U.S. Cl. CPC B32B 37/02; B32B 5/06; B32B 7/022; B32B 27/12; B32B 37/08; B32B 37/10; B32B 38/0004; B32B 38/0012; B32B 43/003; B32B 2250/04; B32B 2260/021; B32B 2307/51; B32B 2307/718; B32B 2309/02; B32B 2309/04; B32B 2367/00

(57) ABSTRACT

A rough board compositing process, comprising the following steps: S1: pre-treating raw materials; S2: pre-cutting materials; S3: performing first hot pressing fusion; S4: obtaining a faceplate layer core material after the hot pressing fusion; S5: cutting a demoulding cloth, a third resin layer, a supporting structure layer and a release film material; S6: stacking the materials one by one; S7: performing second hot pressing fusion to obtain a composite board; and S8: tearing off the demoulding cloth from the composite board to obtain a final product, a composite rough board. By the described process, a lightweight and durable composite rough board is obtained. The composite rough board is capable of effectively increasing striking resistance and prolonging service life. The composite fabric is suitable for covering beach rackets or pickleball rackets to improve durability and striking resistance.

### BACKGROUND OF THE INVENTION

### 1. Technical Field

The present invention relates to the technical field of ball sports equipment and, in particular, to the technical field of rough board composite fabrics for beach rackets and pickleball rackets.

### 2. Description of Related Art

The fabric used on the rough board usually needs to meet the requirements of durability and striking resistance. A beach racket or pickleball racket is usually covered with a surface fabric to meet the requirements of striking resistance and resilience, so the requirements for the fabric material are relatively high. In the prior art, foam materials are also used as the covering material of racket faceplate. For example, patent publication CN202210359735.8, entitled “Lightweight and Wear-resistant Carbon Fiber Pickleball Racket and Manufacturing Method Thereof”, discloses: making a core board: installing two carbon fiber boards in a mold, adjusting the spacing and fixing the positions of the carbon fiber boards; then, injecting foam rubber into an interlayer, and then allowing the foam rubber to be vulcanized and foamed to obtain the core board. Because foam materials have fatigue limits and are prone to aging problems, such foam materials are generally not resistant to repeated hitting. After a certain period of use, aging damage will be caused, resulting in a limited service life of the racket; or after a period of use, the flexibility and hitting effect of the racket will be affected, the rebound feel of the racket after hitting a ball will not be clear enough, and the hitting feel will be greatly affected.

### BRIEF SUMMARY OF THE INVENTION

In view of the above problems, the present invention provides a composite fabric capable of effectively increasing the striking resistance and prolonging the service life. The composite fabric is suitable for covering a beach racket or a pickleball racket. This rough surface material is prepared by a twice-compositing process. A composite rough board is applied to the production of rackets, achieving the advantages of comfortable hitting feel and durable protective layer structure and ensuring the lightweight and durability of the rackets as a whole.

The present invention relates to a rough board compositing process, including the following steps:
S1: pre-treating raw materials, wherein a fiberglass fabric is pre-cured and then subjected to surface roughening pre-treatment to obtain a cured fiberglass board layer;
S2: pre-cutting a first resin layer, a fiber layer fabric, the cured fiberglass board layer and a second resin layer into a same size and area and stacking the first resin layer, the fiber layer fabric, the cured fiberglass board layer and the second resin layer one by one;
S3: placing the stacked materials from step S2 into a mold for first hot pressing fusion;
S4: obtaining a faceplate layer core material after the first hot pressing fusion, and cooling the material;
S5: cutting a demoulding cloth, a third resin layer, a supporting structure layer and a release film material according to the size and area of the faceplate layer core material;
S6: stacking the cut demoulding cloth, third resin layer, faceplate layer core material, supporting structure layer and release film one by one, wherein the faceplate layer core material is cooled to room temperature;
S7: placing all the stacked materials from step S6 into a mold for a second hot pressing fusion to obtain a preliminary composite board, and cooling the preliminary composite board; and
S8: tearing off the demoulding cloth from the completely cooled composite board to obtain a final product, a composite rough board.

The fiber layer fabric in step S2 is polyester fiber, nylon cloth, stainless steel mesh cloth, aluminum mesh cloth or copper mesh cloth.

The polyester fiber has a parameter of 10 g/m²-200 g/m² and an elastic modulus of 22-141 cN/dtex.

The stainless steel mesh cloth, the aluminum mesh cloth, brass mesh cloth and red copper mesh cloth have a mesh number ranging from 80 meshes to 350 meshes.

In step S5, the supporting structure layer is made of a carbon fiber material or a fiberglass material.

In step S3, the first hot pressing fusion is segmented pressurized heating fusion, which includes three separate stages of pressurized heating process, wherein a first stage is performed at a pressure of 0 ton and a temperature of 80-120° C. for 20-50 s, a second stage is performed at a pressure of 1-3 ton and a temperature of 120-145° C. for 70-100 s, and a third stage is performed at a pressure of 5-10 ton and a temperature of 120-145° C. for 900-1200 s.

In step S4, the material obtained after the first hot pressing fusion is cooled and pressed by a cold press at a pressure of 3-5 ton and a temperature of 5-10° C. for 300-600 s.

In step S7, the second hot pressing fusion is segmented pressurized heating fusion, which includes four separate stages of pressurized heating process, wherein a first stage is performed at a pressure of 0 ton and a temperature of 80-120° C. for 20-50 s, a second stage is performed at a pressure of 1-3 ton and a temperature of 120-150° C. for 70-100 s, a third stage is performed at a pressure of 3-5 ton and a temperature of 130-150° C. for 100-200 s, and a fourth stage is performed at a pressure of 8-10 ton and a temperature of 135-150° C. for 1000-1200 s.

In step S7, the material obtained after the second hot pressing fusion is cooled and pressed by a cold press at a pressure of 3-5 ton and a temperature of 5-10° C. for 300-600 s.

The faceplate layer core material obtained by the first hot pressing fusion is sandwiched with a polyester fiber material or a stainless steel mesh cloth, a copper mesh cloth, and the like, and a resin material with good composite flexibility is composited on outer layers of the faceplate layer core material, thus obtaining the rough board composite fabric of the present invention. The faceplate layer core material obtained by a segmented pressurized heating process is pressed and combined tightly and firmly, and then the second hot pressing fusion is performed to obtain a lightweight and durable composite rough board, which is a composite fabric capable of effectively increasing striking resistance and prolonging service life. The composite fabric is suitable for covering beach rackets or pickleball rackets to improve durability and striking resistance.

### DETAILED DESCRIPTION OF THE INVENTION

The invention will be described in detail below in conjunction with the accompanying embodiments. The embodiments described below are exemplary and only for explaining the invention rather than being construed as limiting the invention.

In the description of the invention, it should be appreciated that the orientations or positional relationships, indicated by the terms “center”, “upper”, “lower”, “front”, “rear”, “left”, “right”, “vertical”, “horizontal”, “top”, “bottom”, “inside”, “outside” and the like, are based on the orientations are only for the purpose of facilitating and simplifying the description of the present invention, rather than indicating or implying that the described device or element must have a particular orientation or must be constructed and operated in a particular orientation, and therefore they should not be construed as limiting the invention.

The present invention relates to a rough board compositing process, including the following steps:
S1: pre-treating raw materials, wherein a fiberglass fabric is pre-cured and then subjected to surface roughening pre-treatment to obtain a cured fiberglass board layer; in the operation of pre-treating the fiberglass fabric, the position of the fiberglass fabric can be fixed so that the displacement of the fabric is reduced and the movement is effectively prevented.
S2: pre-cutting a first resin layer, a fiber layer fabric, the cured fiberglass board layer and a second resin layer into a same size and area and stacking the first resin layer, the fiber layer fabric, the cured fiberglass board layer and the second resin layer one by one;

The used first resin layer and second resin layer may be made of a solid resin material or a liquid resin. If a solid resin is used, a resin sheet is cut; if a liquid resin is used, the liquid resin can be applied to the fiber layer fabric and the cured fiberglass board layer.
S3: placing the stacked materials from step S2 into a mold for first hot pressing fusion;
S4: obtaining a faceplate layer core material after the first hot pressing fusion, and cooling the material;
S5: cutting a demoulding cloth, a third resin layer, a supporting structure layer and a release film material according to the size and area of the faceplate layer core material;
S6: stacking the cut demoulding cloth, third resin layer, faceplate layer core material, supporting structure layer and release film one by one, wherein the faceplate layer core material is cooled to room temperature;
S7: placing all the stacked materials from step S6 into a mold for second hot pressing fusion to obtain a preliminary composite board, and cooling the preliminary composite board; and
S8: tearing off the demoulding cloth from the completely cooled composite board to obtain a final product, a composite rough board.

The fiber layer fabric in step S2 is polyester fiber, nylon cloth, stainless steel mesh cloth, aluminum mesh cloth or copper mesh cloth.

The polyester fiber has a parameter of 10 g/m²-200 g/m² and an elastic modulus of 22-141 cN/dtex.

The stainless steel mesh cloth, the aluminum mesh cloth, brass mesh cloth and red copper mesh cloth have a mesh number ranging from 80 meshes to 350 meshes.

In step S5, the supporting structure layer is made of a carbon fiber material or a fiberglass material.

In step S3, the first hot pressing fusion is segmented pressurized heating fusion, which includes three separate stages of pressurized heating process, wherein a first stage is performed at a pressure of 0 ton and a temperature of 80-120° C. for 20-50 s, a second stage is performed at a pressure of 1-3 ton and a temperature of 120-145° C. for 70-100 s, and a third stage is performed at a pressure of 5-10 ton and a temperature of 120-145° C. for 900-1200 s.

In step S4, the material obtained after the first hot pressing fusion is cooled and pressed by a cold press at a pressure of 3-5 ton and a temperature of 5-10° C. for 300-600 s.

In step S7, the second hot pressing fusion is segmented pressurized heating fusion, which includes four separate stages of pressurized heating process, wherein a first stage is performed at a pressure of 0 ton and a temperature of 80-120° C. for 20-50 s, a second stage is performed at a pressure of 1-3 ton and a temperature of 120-150° C. for 70-100 s, a third stage is performed at a pressure of 3-5 ton and a temperature of 130-150° C. for 100-200 s, and a fourth stage is performed at a pressure of 8-10 ton and a temperature of 135-150° C. for 1000-1200 s.

In step S7, the material obtained after the second hot pressing fusion is cooled and pressed by a cold press at a pressure of 3-5 ton and a temperature of 5-10° C. for 300-600 s.

### EXAMPLE 1

A compositing process was implemented by the steps S1 to S7.
S1: Raw materials were pre-cured, where a fiberglass fabric was pre-cured and then subjected to surface roughening pre-treatment to obtain a cured fiberglass board layer. In the operation of pre-treating the fiberglass fabric, the position of the fiberglass fabric could be fixed so that the displacement of the fabric was reduced and the movement was effectively prevented.
S2: A first resin layer, a fiber layer fabric, the cured fiberglass board layer and a second resin layer were pre-cut into a rectangular area of 15 cm (L)*6 cm (W) and then stacked one by one.

In this example, a solid resin material was used, so the first resin layer and the second resin layer were cut to a size of 15 cm*6 cm.
S3: The stacked materials from step S2 were placed into a mold for first hot pressing fusion. The first hot pressing fusion was three-stage pressurized heating fusion, where a first stage was performed at a pressure of 0 ton and a temperature of 100° C. for 30 s, a second stage was performed at a pressure of 1.8 ton and a temperature of 130° C. for 80 s, and a third stage was performed at a pressure of 8 ton and a temperature of 135° C. for 1000 s.
S4: A faceplate layer core material was obtained after the first hot pressing fusion, and then cooled. The material was cooled and pressed by a cold press at a pressure of 4 ton and a temperature of 8° C. for 500 s until the material was cooled to room temperature.
S5: A demoulding cloth, a third resin layer, a supporting structure layer and a release film material were cut into a rectangular area of 15 cm (L)*6 cm (W) according to the size and area of the faceplate layer core material.
S6: The cut demoulding cloth, third resin layer, faceplate layer core material, supporting structure layer and release film were stacked one by one, where the faceplate layer core material was cooled to room temperature.
S7: All the stacked materials from step S6 were placed into a mold for a second hot pressing fusion to obtain a preliminary composite board, and the preliminary composite board was cooled.

The second hot pressing fusion was segmented pressurized heating fusion, which included four separate stages of pressurized heating process, where a first stage was performed at a pressure of 0 ton and a temperature of 90° C. for 40 s, a second stage was performed at a pressure of 3 ton and a temperature of 140° C. for 80 s, a third stage was performed at a pressure of 4.5 ton and a temperature of 150° C. for 150 s, and a fourth stage was performed at a pressure of 8 ton and a temperature of 150° C. for 1200 s.

The material obtained after the second hot pressing fusion was cooled and pressed by a cold press at a pressure of 3 ton and a temperature of 6° C. for 400 s.
S8: The demoulding cloth was torn off from the cooled composite board to obtain a final product, a composite rough board.

### EXAMPLE 2

Example 2 differs from Example 1 in that: in this example, the fiber layer fabric was an aluminum mesh cloth with 180 meshes.

In step S3, a three-stage pressurized heating process was implemented, where a first stage was performed at a pressure of 0 ton and a temperature of 110° C. for 40 s, a second stage was performed at a pressure of 3 ton and a temperature of 135° C. for 100 s, and a third stage was performed at a pressure of 10 ton and a temperature of 140° C. for 1200 s.

In step 7, the second hot pressing fusion was segmented pressurized heating fusion, which included four separate stages of pressurized heating process, where a first stage was performed at a pressure of 0 ton and a temperature of 100° C. for 40 s, a second stage was performed at a pressure of 3 ton and a temperature of 145° C. for 90 s, a third stage was performed at a pressure of 4.5 ton and a temperature of 150° C. for 200 s, and a fourth stage was performed at a pressure of 10 ton and a temperature of 150° C. for 1200 s.

The material obtained after the second hot pressing fusion was cooled and pressed by a cold press at a pressure of 5 ton and a temperature of 5° C. for 600 s.

The faceplate layer core material obtained by the first hot pressing fusion is sandwiched with a polyester fiber material or a stainless steel mesh cloth, a copper mesh cloth, and the like, and a resin material with good composite flexibility is composited on outer layers of the faceplate layer core material, thus obtaining the rough board composite fabric of the present invention. The faceplate layer core material obtained by a segmented pressurized heating process is pressed and combined tightly and firmly, and then the second hot pressing fusion is performed to obtain a lightweight and durable composite rough board, which is a composite fabric capable of effectively increasing striking resistance and prolonging service life. The composite fabric is suitable for covering beach rackets or pickleball rackets to improve durability and striking resistance.

The advantages of the composite rough board fabric produced by the described rough board compositing process are as follows: the strength and flexibility of the faceplate are increased; a metal fabric can also be electroplated to increase the metallic color and enhance the beauty; due to the polyester fiber or nylon cloth sandwiched in the composite rough board fabric, the impact resistance and striking resistance can be improved, the supporting structure layer is strongly and effectively protected, the impact on the supporting structure layer is prevented, and in a case where the carbon fiber or fiberglass breaks, the structure can be kept from splashing and breaking, thereby avoiding injury to users; moreover, users have a clear sense of hitting the ball.

The foregoing are merely preferred embodiments of the invention and not intended to limit the invention in any form. While the invention has been disclosed as above by way of the preferred embodiments, it is not intended to limit the present invention. Any person skilled in the art may make some changes or equivalent embodiments modified as equivalents without departing from the scope of the invention on the basis of the described technical contents; any of changes, equivalent, and modifications made to the foregoing embodiments without departing from the spirit of the technical solution of the invention in accordance with the technical essence of the invention is within the scope of the technical solution of the invention.

What is claimed is:

1. A rough board compositing process, comprising the following steps:
S1: pre-treating raw materials, wherein a fiberglass fabric is pre-cured and then subjected to surface roughening pre-treatment to obtain a cured fiberglass board layer;
S2: pre-cutting a first resin layer, a fiber layer fabric, the cured fiberglass board layer and a second resin layer into a same size and area and stacking the first resin layer, the fiber layer fabric, the cured fiberglass board layer and the second resin layer one by one;
S3: placing the stacked materials from step S2 into a mold for first hot pressing fusion;
S4: obtaining a faceplate layer core material after the first hot pressing fusion, and cooling the material;
S5: cutting a demoulding cloth, a third resin layer, a supporting structure layer and a release film material according to the size and area of the faceplate layer core material;
S6: stacking the cut demoulding cloth, third resin layer, faceplate layer core material, supporting structure layer and release film one by one, wherein the faceplate layer core material is cooled to room temperature;
S7: placing all the stacked materials from step S6 into a mold for a second hot pressing fusion to obtain a preliminary composite board, and cooling the preliminary composite board; and
S8: tearing off the demoulding cloth from the completely cooled composite board to obtain a final product, a composite rough board.

2. The rough board compositing process according to claim 1, wherein the fiber layer fabric in step S2 is polyester fiber, nylon cloth, stainless steel mesh cloth, aluminum mesh cloth, or brass/red copper mesh cloth.

3. The rough board compositing process according to claim 2, wherein the polyester fiber has a parameter of 10 g/m²-200 g/m² and an elastic modulus of 22-141 cN/dtex.

4. The rough board compositing process according to claim 2, wherein the stainless steel mesh cloth, the aluminum mesh cloth, the brass mesh cloth and the red copper mesh cloth have a mesh number ranging from 80 meshes to 350 meshes.

5. The rough board compositing process according to claim 1, wherein in step S5, the supporting structure layer is made of a carbon fiber material or a fiberglass material.

6. The rough board compositing process according to claim 1, wherein in step S3, the first hot pressing fusion is segmented pressurized heating fusion, which comprises three separate stages of pressurized heating process, wherein a first stage is performed at a pressure of 0 ton and a temperature of 80-120° C. for 20-50 s, a second stage is performed at a pressure of 1-3 ton and a temperature of 120-145° C. for 70-100 s, and a third stage is performed at a pressure of 5-10 ton and a temperature of 120-145° C. for 900-1200 s.

7. The rough board compositing process according to claim 6, wherein in step S4, the material obtained after the first hot pressing fusion is cooled and pressed by a cold press at a pressure of 3-5 ton and a temperature of 5-10° C. for 300-600 s.

8. The rough board compositing process according to claim 1, wherein in step S7, the second hot pressing fusion is segmented pressurized heating fusion, which comprises four separate stages of pressurized heating process, wherein a first stage is performed at a pressure of 0 ton and a temperature of 80-120° C. for 20-50 s, a second stage is performed at a pressure of 1-3 ton and a temperature of 120-150° C. for 70-100 s, a third stage is performed at a pressure of 3-5 ton and a temperature of 130-150° C. for 100-200 s, and a fourth stage is performed at a pressure of 8-10 ton and a temperature of 135-150° C. for 1000-1200 s.

9. The rough board compositing process according to claim 8, wherein in step S7, the material obtained after the second hot pressing fusion is cooled and pressed by a cold press at a pressure of 3-5 ton and a temperature of 5-10° C. for 300-600 s.
